(19) United States
(12) Patent Application Publication
(10) Pub. No.: US 2026/0352151 A1
(43) Pub. Date: Nov. 5, 2026

(54) SOLAR INSTALLATION COMPRISING SOLAR PANELS AND SUSPENDED NON-OBSCURING PANELS

(71) Applicant: POMA, Voreppe (FR)

(72) Inventor: Mathieu BABAZ, Saint Étienne de Crossey (FR)

(73) Assignee: POMA, Voreppe (FR)

(21) Appl. No.: 19/642,031

(22) Filed: Apr. 8, 2026

(30) Foreign Application Priority Data
Apr. 30, 2025 (FR) FR2504599

(51) Int. Cl. H02S 40/20; F24S 25/40; F24S 25/70; H02S 20/30

(52) U.S. Cl. CPC H02S 40/20; F24S 25/40; F24S 25/70; H02S 20/30

(57) ABSTRACT

The invention relates to a solar installation including a supporting structure that includes two support cables parallel to a reference direction, and a row of panels arranged along the reference direction, each of the panels being suspended by the two support cables, the row of panels including panels at least some of which are tiltable panels which are each tiltable at least between a covering position and an open position by pivoting about a pivoting axis perpendicular to the reference direction, at least some of the tiltable panels each including at least one photovoltaic and/or solar thermal active element forming a sub-assembly of active panels, the row of panels forming a continuous cover when the tiltable panels are in the covering position, the solar installation being characterized in that at least some of the panels have at least one inactive portion which does not include an active element.

### CROSS-REFERENCE TO RELATED APPLICATION

This application claims priority under 35 U.S.C. 119 to French Patent Application No. 2504599, filed Apr. 30, 2025; this disclosure of which is incorporated herein by reference in its entirety.

### TECHNICAL FIELD OF THE INVENTION

The invention relates generally to the field of solar installations comprising solar, photovoltaic or solar thermal panels suspended from a structure, in particular cables.

In addition, the invention relates to the fields of ground cover structures for managing solar exposure, rainwater or frost exposure, for example in agriculture or in urban environments.

### STATE OF THE PRIOR ART

Document EP4362323 discloses a solar system comprising a support having two support cables and photovoltaic panels supported by said cables, the panels forming a row of panels. The photovoltaic panels are spaced apart by a predetermined distance and can be tilted, that is, moved, simultaneously in the same direction. A disadvantage of such a solar installation is the inability to manage the panels distinctly according to their assigned position along the row of panels, for example when the row of panels follows two distinct sloping lines. The orientation of the panels towards the sun is then not optimized based on the positioning of each panel along the row.

In addition, other disadvantages arise from this solar installation, for example the inability to manage rainwater where runoff is not directed, or to protect partially covered ground from frost. This solution is then not suitable for agricultural applications, for example.

To overcome this problem, document US2024243692, for example, proposes a solar system comprising a row of photovoltaic panels superimposed like roof shingles. In this way, the row of panels forms a continuous cover, protecting the ground and directing rainwater runoff. These panels are nevertheless fixed. Indeed, it is complicated to orientate panels when they cannot pivot freely because one or more adjacent panels restrict their rotational movements.

This configuration generates risks of deterioration of the panels depending on weather conditions (hail, strong gusts), and is not optimized in terms of energy production yield due to the fixed orientation of the panels and, optionally, the yield of agricultural land located below these rows of panels, due to excessive shading reducing the sun exposure time of the plants on the land.

### DISCLOSURE OF THE INVENTION

The invention aims to remedy some or all of the shortcomings of the state of the art and to provide a solar installation that maximizes the energy collected by each solar panel and protects the underlying ground.

To this end, according to a first aspect of the invention, a solar installation is proposed comprising a supporting structure parallel to a reference direction, and a row of panels arranged along the reference direction, each of the panels being suspended by the supporting structure, the row of panels comprising at least a first sub-assembly of tiltable panels which are each tiltable at least between a covering position and an open position by pivoting about a pivoting axis perpendicular to the reference direction and which each comprise at least one photovoltaic and/or solar thermal active element, the solar installation being remarkable in that the row of panels comprises at least one sub-assembly of non-obscuring panels, each comprising at least one completely transparent portion at least in a range of wavelengths comprised between 350 nm and 1200 nm and which, in the covering position, allows incident light to pass through said non-obscuring panels, the non-obscuring panels being positioned so that, in the covering position, the active elements of any two successive tiltable panels of the first sub-assembly of tiltable panels are arranged along the reference direction on either side of at least one completely transparent portion of one of the non-obscuring panels.

In this way, the completely transparent portion of the non-obscuring panels enables the active elements belonging to two successive tiltable panels to be spaced apart, so that, regardless of the tilt of the tiltable panels, within an operational tilting range, a given active element is not in the shadow of an active element of an adjacent panel. The non-obscuring panels also contribute to ground coverage in the covering position, so that the proposed solution combines good sunlight for the active elements with good coverage in the covering position.

In one embodiment, the sub-assembly of non-obscuring panels and the first sub-assembly of tiltable panels are separate. The tiltable panels of the first sub-assembly are preferably completely covered with active elements. The non-obscuring panels are preferably completely transparent.

The non-obscuring panels can be fixed. Alternatively, they can each be tilted at least between a covering position and an open position by pivoting about a pivoting axis perpendicular to the reference direction.

According to another embodiment, the first sub-assembly of tiltable panels is included in the sub-assembly of non-obscuring panels. In other words, each tiltable panel of the first sub-assembly comprises both at least one active element and a completely transparent portion.

In one particularly versatile embodiment, the sub-assembly of non-obscuring panels comprises a second sub-assembly of tiltable panels, each of which is tiltable at least between a covering position and an open position by pivoting about a pivoting axis perpendicular to the reference direction, the first and second sub-assemblies of tiltable panels being separate. In particular, the tiltable panels of the first sub-assembly of tiltable panels are connected by a first pivoting control cable extending parallel to the reference direction, and the tiltable panels of the second sub-assembly of tiltable panels are connected by a second pivoting control cable extending parallel to the reference direction. In this case, the sub-assembly of non-obscuring panels may include the panels of the first sub-assembly of tiltable panels and the second sub-assembly of tiltable panels. Preferably, any two successive tiltable panels of the first sub-assembly of tiltable panels are separated by a tiltable panel of the second sub-assembly of tiltable panels, and any two successive tiltable panels of the second sub-assembly of tiltable panels are separated by a tiltable panel of the first sub-assembly of tiltable panels. Where applicable, the tiltable panels of the second sub-assembly of tiltable panels each comprise at least one photovoltaic and/or solar thermal active element. Alternatively, the panels can be completely transparent. The tiltable panels of the second sub-assembly can be maneuvered independently of the tiltable panels of the first sub-assembly, making certain maneuvers easier, or enabling configurations to be achieved that would not otherwise be possible.

Preferably, in the covering position, the row of panels forms a continuous cover. Continuous means that there is no noticeable gap between two adjacent panels in the row in the covering position. In a first variant, in the covering position, the panels of the row of panels partially overlap and form a shingle arrangement along the reference position. In a second variant, in the covering position, the tiltable panels come into contact with each other without overlapping along the reference direction.

Advantageously, the completely transparent portion of the non-obscuring panels is opaque or at least partially opaque in a range of wavelengths greater than 5 µm. One material that can be used is plexiglass. The advantage of such behavior is that it combines transparency in the useful range for the active elements of solar panels with opacity in the mid-infrared range, which limits the thermal radiation of the ground at night. This creates a greenhouse effect in winter, protecting the underlying ground from frost.

### BRIEF DESCRIPTION OF FIGURES

Other features and advantages of the invention will become apparent on reading the following description, with reference to the appended figures, which show:

FIG. 1: a schematic side view of a solar installation comprising a row of tiltable panels in accordance with the invention, according to a first embodiment.

FIG. 2: an isometric view of the row of panels according to the first embodiment.

FIG. 3A: a schematic view of three successive tiltable panels of the row of panels, in a first, so-called covering position, according to the first embodiment.

FIG. 3B: a schematic view of three successive tiltable panels of the row of panels, in a second position, according to the first embodiment.

FIG. 3C: a schematic view of three successive tiltable panels of the row of panels, in a third position, according to the first embodiment.

FIG. 3D: a schematic view of three successive tiltable panels of the row of panels, in a fourth position, according to the first embodiment.

FIG. 3E: a schematic view of three successive tiltable panels of the row of panels, in a fifth position, according to the first embodiment.

FIG. 3F: a schematic view of three successive tiltable panels of the row of panels, in a sixth, so-called covering position, according to the first embodiment.

FIG. 4A: a schematic view of three successive tiltable panels of the row of panels, in a first, so-called covering position, according to a second embodiment.

FIG. 4B: a schematic view of three successive tiltable panels of the row of panels, in a second position, according to the second embodiment.

FIG. 4C: a schematic view of three successive tiltable panels of the row of panels, in a third position, according to the second embodiment.

FIG. 4D: a schematic view of three successive tiltable panels of the row of panels, in a fourth position, according to the second embodiment.

FIG. 4E: a schematic view of three successive tiltable panels of the row of panels, in a fifth position, according to the second embodiment.

FIG. 4F: a schematic view of three successive tiltable panels of the row of panels, in a sixth position, according to the second embodiment.

FIG. 5: a schematic view of three successive tiltable panels of a row of panels, in a first, so-called covering position, according to a third embodiment.

FIG. 6: a schematic side view of a solar installation comprising a row of tiltable panels, according to a fourth embodiment.

FIG. 7: a schematic side view of a solar installation comprising a row of tiltable panels, according to a fifth embodiment.

FIG. 8: a schematic view of three successive tiltable panels of a row of panels of a solar installation according to a sixth embodiment.

FIG. 9: a schematic view of three successive tiltable panels of a row of panels of a solar installation according to a seventh embodiment.

For greater clarity, identical or similar elements are identified by identical reference signs in all of the Figures.

### DETAILED DESCRIPTION OF ONE EMBODIMENT

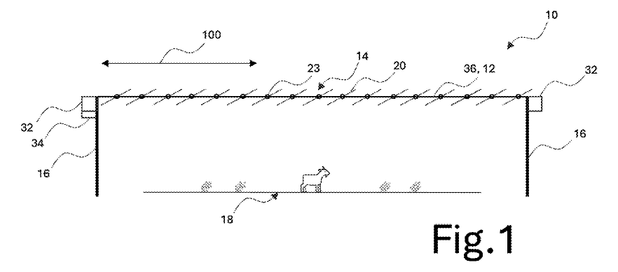

FIG. 1 illustrates a solar installation 10 according to a first embodiment comprising a supporting structure 36 configured to support at least one row of panels 14 and extending in a reference direction 100 between at least two pylons 16 of the supporting structure 36. Here, the row of panels 14 is arranged at a distance above agricultural land 18, but it is also possible to cover other types of ground, for example car parking lots.

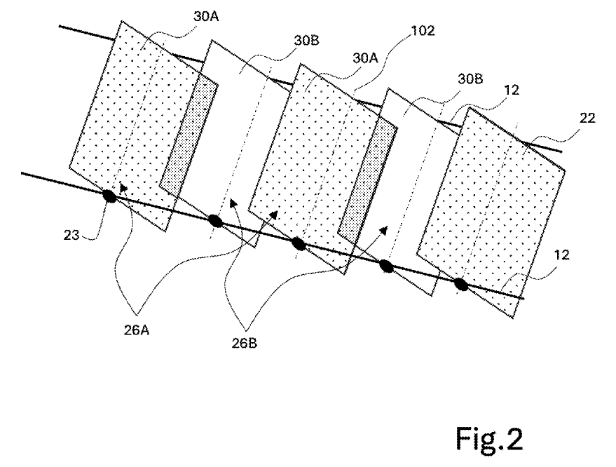

As shown in particular in FIG. 2, the supporting structure 36 comprises, for example, two support cables 12. The two support cables 12 extend between at least the two pylons 16 and are parallel to each other. In this embodiment, the support cables 12 are generally parallel to a level line, that is, the two ends of the two cables 12 have a negligible elevation differential as a function of the length of said support cables 12. The support cables 12 are parallel to the reference direction 100. The support cables 12 are made of one or more materials configured to withstand high loads over a long period of time while being subjected to outdoor weather conditions. In this way, the support cables 12 each have a predetermined composition, structure and cross-sectional dimension to withstand the conditions to which said cables 12 are subjected.

The row of panels 14 comprises a plurality of tiltable panels 20, at least some of which, as will be described later, are solar, photovoltaic or solar thermal panels. Each tiltable panel 20 comprises a generally rectangular body 22 pivotally mounted on two associated pivots 23, fixed to the two support cables 12 and aligned on an associated pivoting axis 102 which is locally perpendicular to the two support cables 12. The body 22 extends longitudinally between the two support cables 12. Each body 22 of a tiltable panel 20 comprises an upper face 24 opposite a lower face of the same tiltable panel 20. Each pivoting axis 102 preferably passes through the center of mass of the associated tiltable panel 20, and, assuming a uniform distribution of the mass of the panel body 22, splits the body 22 of the tiltable panel 20 into two equal parts). As a result, the energy required to pivot each tiltable panel 20 is minimal.

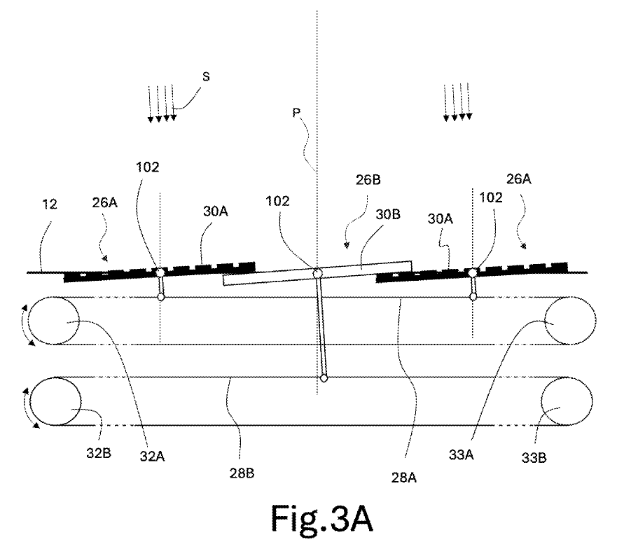

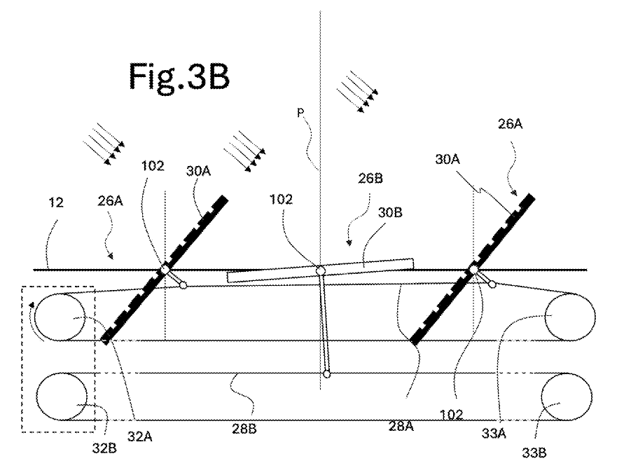

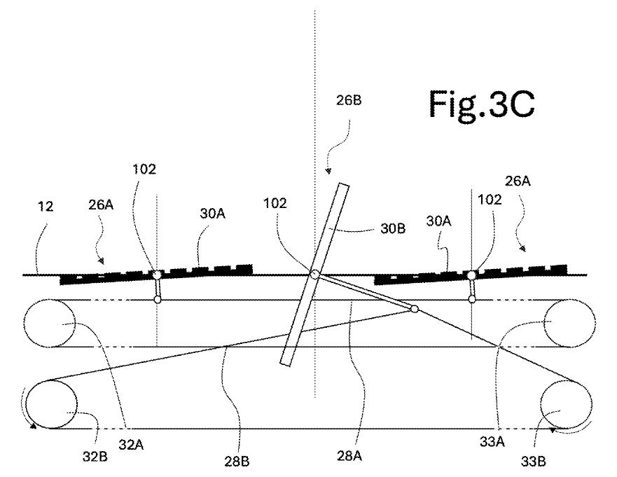

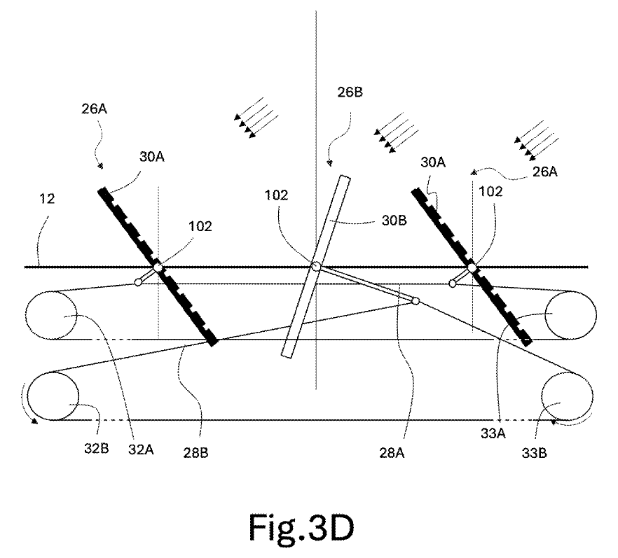

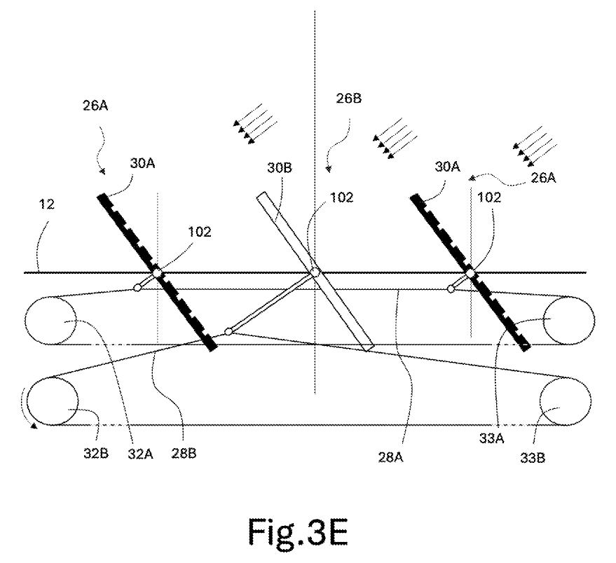

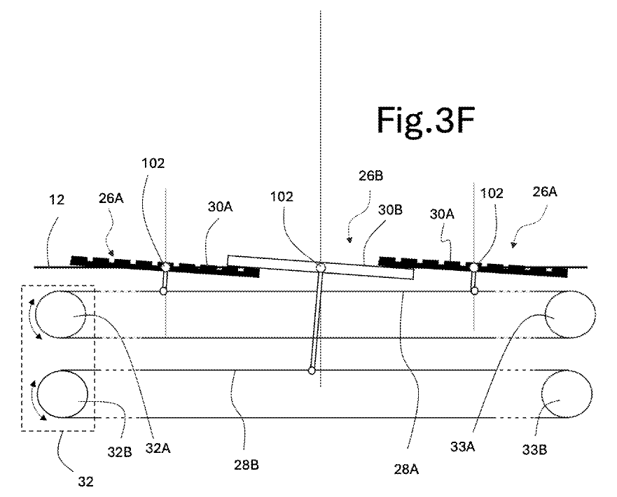

Referring to FIGS. 3A-3E, the tiltable panels 20 are free to rotate about the pivoting axis 102 in a predetermined angular sector greater than 45°, and preferably greater than 60°, for example of the order of 90°, on both sides of a reference position in which the upper face 24 is parallel to the pivoting axis 102 and to the reference direction 100. In this way, each tiltable panel 20 can assume at least one so-called “covering” position (in this case two covering positions, exemplified in FIG. 3A and 3F, close to the reference position) and “open” positions (for example exemplified in FIGS. 3B or 3D).

In this embodiment, two pivoting axes of successive tiltable panels 20 are spaced apart by a predetermined distance greater than half the width of a panel and less than the width of a panel, this width being the dimension of the upper face 24 perpendicular to the pivoting axis 102. Thus, in the covering positions illustrated in FIGS. 3A and 3E, the two adjacent tiltable panels 20 partially overlap. The row of panels 14 then continuously covers the underlying ground.

The tiltable panels 20 are divided into two sub-assemblies 26A, 26B.

A first sub-assembly 26A consists of tiltable panels 20 linked to a first control cable 28A, so that pulling on the first control cable 28A in a given direction causes the tiltable panels 20 of the first sub-assembly 26A to pivot about their respective pivoting axes 102. The tiltable panels 20 of the first sub-assembly 26A each feature at least one photovoltaic and/or solar thermal active element 30A positioned on the upper face 24 of the body 22. In this case, in this embodiment, the active element or elements 30A cover the entire upper face 24 of the body 22.

A second sub-assembly 26B, separate from the first sub-assembly 26A, consists of tiltable panels 20 linked to a second control cable 28B, so that pulling on the second control cable 28B in a given direction causes the tiltable panels 20 of the second sub-assembly 26A to pivot about their respective pivoting axes 102. In this embodiment, the body 22 of the tiltable panels 20 of the second sub-assembly 26B comprises at least one transparent portion 30B and does not comprise a photovoltaic and/or solar thermal active element 30A. In this case, the tiltable panels 20 of the second sub-assembly 26B are completely transparent. Transparency is understood here and throughout the application to mean a transparency that extends into the useful spectrum for the active elements 30A, for example between 350 nm and 1200 nm. Preferably, the transparent portion 30B is no longer transparent in the mid-infrared spectrum corresponding to the emission wavelengths of ground radiation, especially in the range of wavelengths comprised between 3 µm and 60 µm.

In this embodiment, the first cable 28A forms a first cable loop stretched between a first bidirectional drive pulley 32A and a first receiving pulley 33A. Similarly, the second cable 28B forms a second cable loop stretched between a second bidirectional drive pulley 32B and a second receiving pulley 33A.

The drive pulleys 32A and 32B belong to a motorized assembly 32 controlled by a control device 34. The control device 34 comprises, for example, a microprocessor or a microcontroller. The control device 34 is configured to implement a method for driving the tiltable panels 20, and thus control the motorized elements 32 to drive the tiltable panels 20. The control device 34 can be connected to a clock and a memory which can contain, for example, an abacus indicating the position of the sun as a function of the day of the year and the time of day, or, to put it another way, the tilt of the panels to ensure maximum sunlight.

The control device 34 can also be connected to various sensors. The installation comprises, by way of example, a brightness sensor, a precipitation detector, an anemometer, a motion sensor, a position sensor and/or an electric current or voltage sensor connected to one or more of the photovoltaic panels among the tiltable panels 20. These measurement elements are configured to collect information characterizing an environmental situation at a specific point in time. Information is collected periodically, for example every 15 minutes. The control device 34 can then control the tiltable panels 20 after determining the environmental situation, based on the information gathered by the measuring elements.

In this embodiment, the tiltable panels 20 of the two sub-assemblies 26A, 26B are arranged alternately along the two support cables 12 to form the row of panels 14. In other words, two successive active tiltable panels 20 of the first sub-assembly 26A are separated by a transparent tiltable panel 20 of the second sub-assembly 26B, and two successive transparent tiltable panels 20 of the second sub-assembly 26A are separated by an active tiltable panel 20 of the first sub-assembly 26B.

Expressed otherwise, the panels 20 of the row of panels 14 are all tiltable, and are subdivided into two separate sub-assemblies, namely the first sub-assembly 26A the panels of which comprise, preferably over their entire upper surface, active elements 30A, and the second sub-assembly 26B, which also constitutes a sub-assembly of non-obscuring panels, which do not comprise active elements, but are entirely transparent, the panels of the sub-assembly of non-obscuring panels being interposed between the panels carrying active elements 30A.

The operation of the system is exemplified in FIGS. 3A-3E. In FIG. 3A, the tiltable panels 20 are in a covering position, for example to protect the underlying ground from precipitation, or to limit radiative cooling of the ground. In this covering position, the coverage offered by the tiltable panels 20 is continuous and the panels are partially overlapping. This position will also be adopted for optimum orientation of the active elements 30A, when the direction of the solar rays S is perpendicular to the upper surface 24 of the panels 20 in the covering position.

To follow the sun, the panels 20 of the first sub-assembly 26A can be tilted from the position of FIG. 3A to the position exemplified in FIG. 3B by actuating the drive pulley 32A, without the need to drive the second sub-assembly 26B.

If, on the other hand, it is sought, starting from the position of FIG. 3A, to tilt the panels 20 of the first sub-assembly 26A into the position of FIG. 3D, it is necessary to pass through an intermediate stage exemplified in FIG. 3C, wherein the panels 20 of the second sub-assembly 26B are tilted, by actuating the drive pulley 32B, into a retracted position which allows the panels 20 of the first sub-assembly to pass through.

If required, a second covering position can be obtained, exemplified in FIG. 3F, which requires, starting from the position in FIG. 3D, first tilting the tiltable panels 20 of the second sub-assembly 26B into the position in FIG. 3E by actuating the drive pulley 32B, then simultaneously actuating the pulleys 32A and 32B to reach the covering position in FIG. 3F.

The transparent tiltable panels 20 of the second sub-assembly 26B interposed between the active elements 30A borne by the tiltable panels 20 of the first sub-assembly allow, in the tilted positions of FIGS. 3B, 3D and 3E, the entirety of the active elements 30A to be exposed to the incident solar rays, without creating an area of shadow. The same applies to the covering positions of FIGS. 3A and 3F, where covering part of the active elements with transparent panels is not a disadvantage. In this way, the installation combines optimum use of the active elements 30A, which can be oriented towards the incident rays and are not subject to areas of shadow, with seamless coverage in the covering positions of FIGS. 3A and 3F. The row of tiltable panels 14 in the first embodiment therefore allows, via the mobility of the tiltable panels 20:
Optimum shade-free orientation of the tiltable panels, so that the 30A active elements are perpendicular to the incident solar rays, to optimize photovoltaic or solar thermal yield in production phases
Covering positions to protect the underlying ground in the event of precipitation or at night;
Wind protection positions, wherein the panels are positioned to minimize their exposure to the wind.

In addition, the presence of transparent portions 30B interposed between the active elements 30A, allows avoiding areas of shadow when the active elements 30A are tilted, which optimizes, for a given surface area of active elements 30A, the recovery of the solar energy.

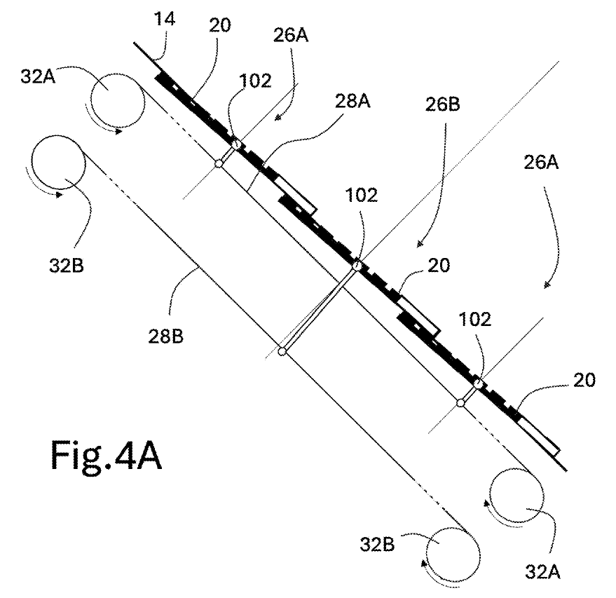

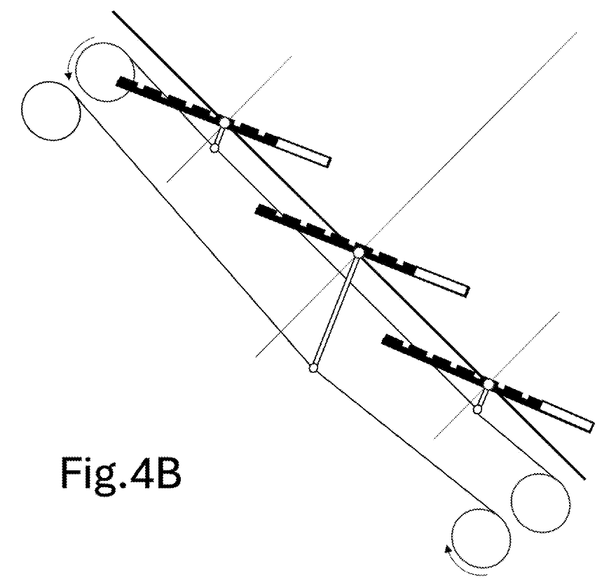

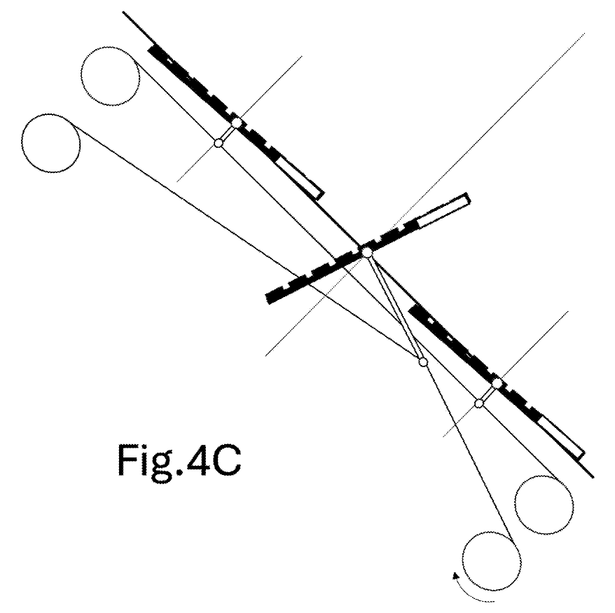

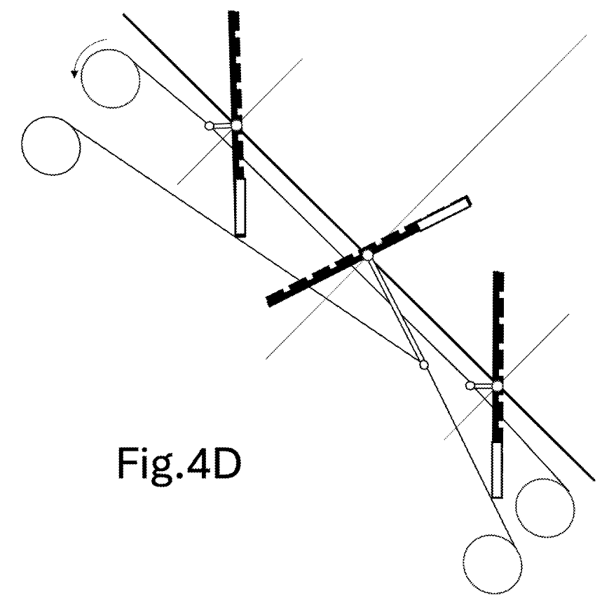

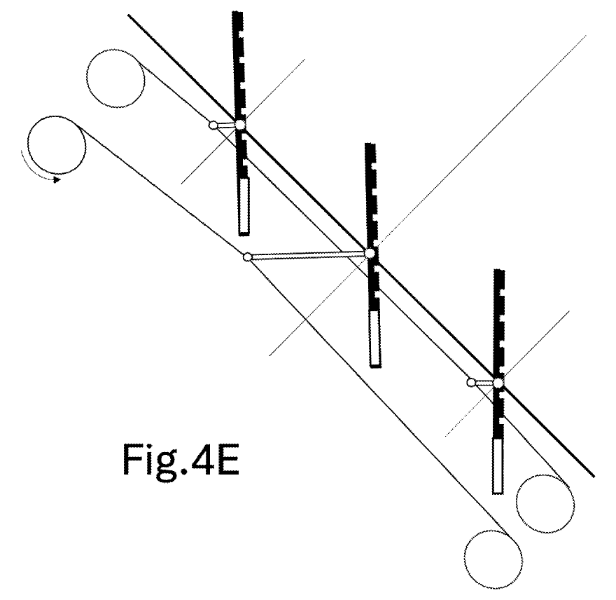

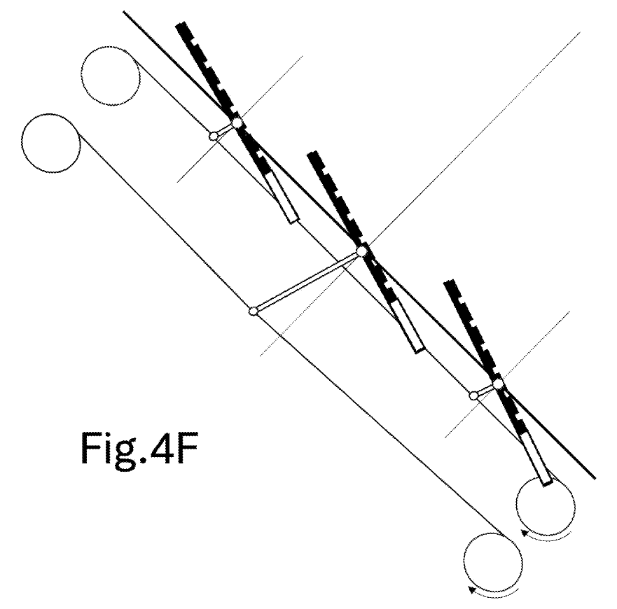

A second embodiment, exemplified in FIGS. 4A-4D, differs from the first embodiment in the following respects:
The reference direction 100 defined by the supporting structure 36 is inclined, for example because the installation is positioned on sloping ground. This tilt is very pronounced on FIGS. 4A-4D, and can be less pronounced if required.
The tiltable panels 20 of the first sub-assembly 26A comprise both at least one photovoltaic or solar thermal active element 30A and at least one transparent portion 30B. In the reference position where the tiltable panel is parallel to the reference direction 100, or in the covering position of FIG. 4A which is close to it, the active element 30A occupies the upper part of the tiltable panel 20 and the transparent portion 30B occupies the lower part of the tiltable panel 20.
The panels 20 of the second sub-assembly 26B comprise both at least one photovoltaic or solar thermal active element 30A and at least one transparent portion 30B. In the reference position where the tiltable panel is parallel to the reference direction 100, or in the covering position of FIG. 4A which is close to it, the active element 30A occupies the upper part of the tiltable panel 20 and the transparent portion 30B occupies the lower part of the tiltable panel 20.
the first cable 28A consists of a cable the ends of which are wound on two opposing motor drums 32A, each capable of pulling the first cable 28A in one direction;
the second cable 28B consists of a cable the ends of which are wound on two opposing motor drums 32B, each capable of pulling the second cable 28B in one direction.

In this embodiment, all the panels 20 in the row of panels 14 can be said to be non-obscuring, since they all comprise a completely transparent portion 30B. The non-obscuring panel assembly is thus subdivided into two sub-assemblies, namely the first sub-assembly 26A and the second sub-assembly 26B, each of which can be independently controlled for tilt.

The installation according to this second embodiment operates as follows.

In the covering position of FIG. 4A, the tiltable panels of the two sub-assemblies 26A and 26B form a seamless shingle arrangement, with the top part of the active elements 30A covered by the transparent portion 30B of an adjacent tiltable panel. In this position, precipitation flows naturally by gravity from one tiltable panel to the other. The part covered by the active elements 30A nevertheless performs its function of capturing solar energy, by virtue of the transparency of the transparent portions 30B.

The transition from the covering position of FIG. 4A to a less inclined position of the panels 20 is performed by actuating the drum motors 32A and 32B as depicted in FIG. 4B.

The transition from the covering position of FIG. 4A to the more inclined position of FIG. 4F requires two transitional intermediate stages exemplified in FIGS. 4C, 4D and 4E, namely a sequence in which firstly (FIG. 4C) the tiltable panels 20 of the second sub-assembly 26B are positioned so as to retract, and secondly (FIG. 4D) to leave the passage clear for the tiltable panels 20 of the first sub-assembly 26A until these are positioned in a transitional position which allows the tiltable panels of the second sub-assembly 26B to be turned over to the position of FIG. 4E, before all the panels can finally be brought into the desired final position of FIG. 4F. In the position of FIG. 4F, the upper part of the active elements 30A casts a shadow on the tiltable panel 20 immediately above in the row of panels 14, but only in the transparent portion 30B, so that the active elements 30A receive full sunlight.

The tilt of the tiltable panels 20 can be controlled according to the declination of the sun, over the course of the year and/or the day. The tilt of the tiltable panels in the covering position of FIG. 4A is chosen, for example, to obtain the best performance on the day of the equinox. The tilt in the position of FIG. 4B is chosen, for example, for each day in spring or summer to obtain the best daytime performance, and the inclination in the position of FIG. 4F is chosen, for example, for each day in autumn or winter to obtain the best daytime performance.

The common feature of the first and second embodiments is that the tiltable panels 20 of the second sub-assembly 26B are interposed between the tiltable panels 20 of the first sub-assembly 26A, allowing, inter alia, the tiltable panels 20 of row 14 to overlap two-by-two in the covering position, while at the same time allowing the tiltable panels 20 to be tilted in both directions with respect to the covering position.

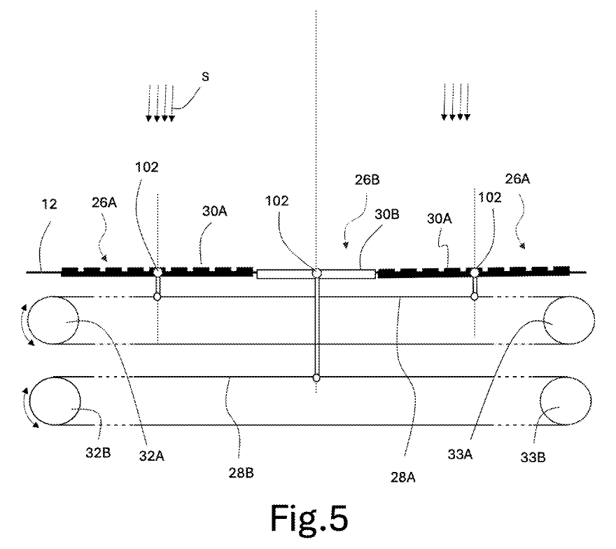

The same advantage is obtained when, as an alternative to the first and second embodiments, the tiltable panels 20 of the two sub-assemblies 26A, 26B are arranged end-to-end in the covering position, without overlapping, according to a third embodiment exemplified, for example, in FIG. 5 in the covering position. In this configuration, the same activation sequences are used as in previous embodiments, to avoid contact when moving from one side to the other of a covering position.

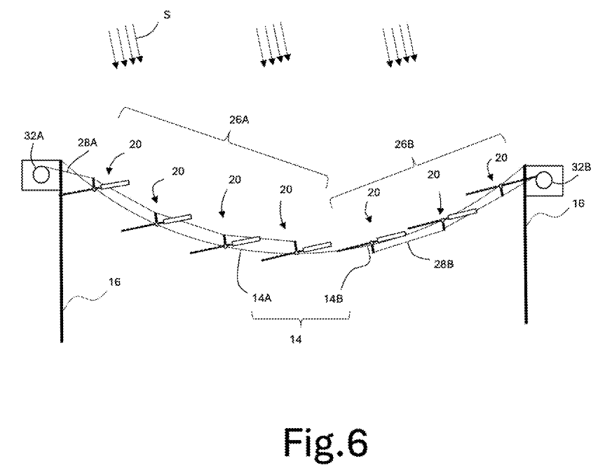

The installation according to the fourth embodiment of FIG. 6 differs from the previous ones in that the tiltable panels 20A of the first sub-assembly 26A are arranged side-by-side along a first part 14A of a supporting chain cable, whereas the tiltable panels 20 of the second sub-assembly 26B are arranged side-by-side along a second part 14B of the supporting chain cable, the parts of the support cable 12 having different slopes, here in opposite directions, which justify controlling the tilt of each sub-assembly 26A, 26B independently, to orientate the assembly of tiltable panels 20 appropriately according to the incident solar rays. As in the second embodiment of FIGS. 4A-4F, it can be provided that each of the tiltable panels 20 comprises an active element 32A and a transparent portion 32B, so that the tiltable panels do not cast a shadow on the active elements 32A of the tiltable panels 20 next along in the row, which would reduce the efficiency of the installation.

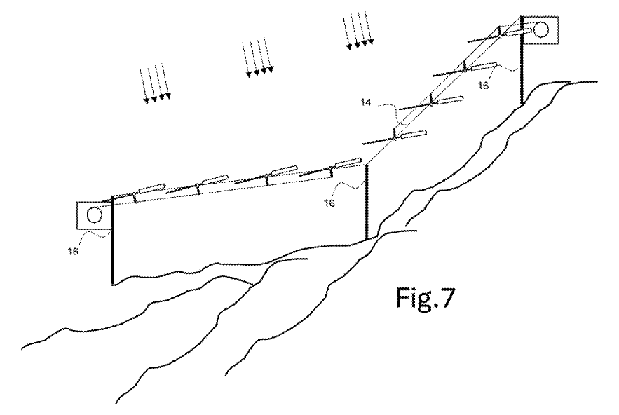

A further example of such an arrangement is provided by the fifth embodiment exemplified in FIG. 7, which differs from the previous one substantially in that the installation equips a site with a variable slope, which is the cause of the difference in slope between the first part 14A of the support cable and the second part 14B of the support cable. The common feature of the installations of FIGS. 6 and 7 is that they are not necessarily covering, in the sense that a sufficient distance is provided between the panels to prevent them from colliding. If required, however, a covering version can be provided as an alternative, provided that precautions are taken to restrict the angular deflection of each sub-assembly 26A, 26B to one side of the covering position only.

More generally, this embodiment exemplifies that the invention can have as many control cables as there are portions of rows of tiltable panels 14 following different lines of slope, and as many discrete sub-assemblies of panels 20 as there are control cables.

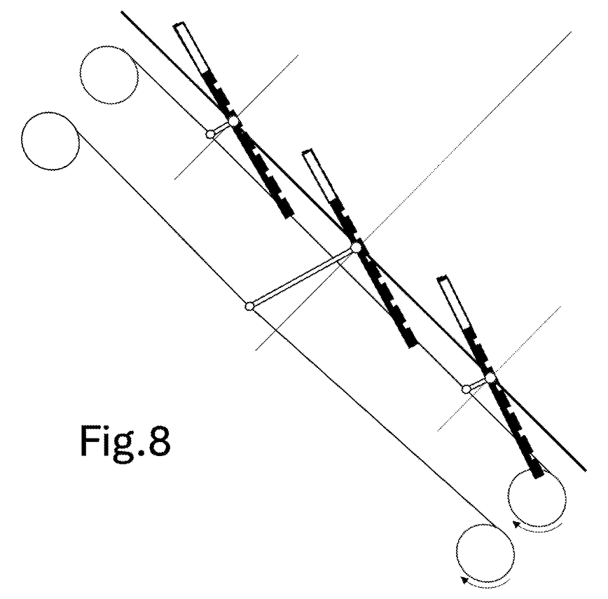

A sixth embodiment, exemplified in FIG. 8, differs from the second embodiment in that the transparent portions 30B are arranged in the upper part of the tiltable panels 20.

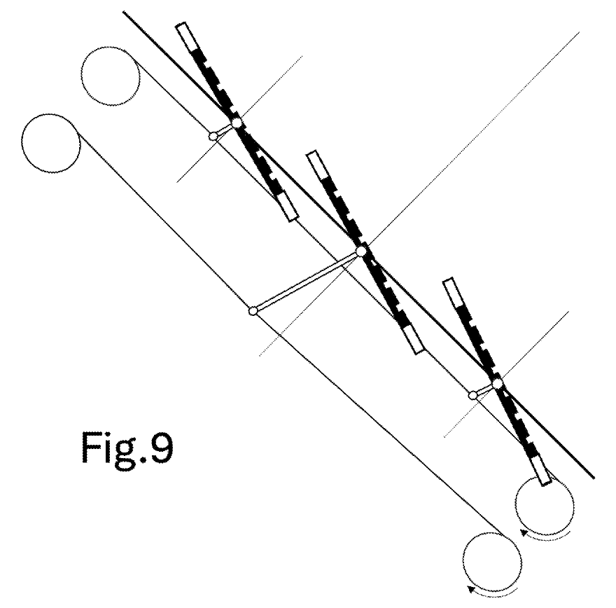

A seventh embodiment, exemplified in FIG. 9, differs from the second embodiment in that the tiltable panels 20 of the first and second sub-assemblies 26B each comprise an active element 30A framed by two transparent portions 30B.

An eighth embodiment, not shown, differs from the previous embodiments in that the pivots 23 define a pivoting axis 102 which is offset with respect to the center of gravity of the panels 20 and with respect to the geometric barycenter of the panels 20. The pivoting axis 102 can, for example, coincide with an edge of the panel extending from one of the support cables 12 to the other, or at least be closer to such an edge than to the center of gravity of the panel 20. This may be true for all the tiltable panels 20, or for some of them only, for example the tiltable panels 20 of the first sub-assembly 26A or those of the second sub-assembly 26B.

A ninth embodiment, not shown, differs from the previous embodiments in that all or some of the tiltable panels 20, for example, the tiltable panels 20 of the first sub-assembly 26A or those of the second sub-assembly 26B, have, along a transverse edge a water collection element, for example a gutter.

A ninth embodiment, not shown, differs from the previous embodiments in that the panels 20 of the non-obscuring panel sub-assembly 20' are fixed. It is therefore no longer necessary for the system 10 to have two control cables 28, as a single control cable is sufficient to form a single moving subassembly.

Of course, the invention is described in the foregoing by way of example. It is understood that a person skilled in the art is able to produce different variant embodiments of the invention without departing from the scope of the invention.

The tiltable panels 20 can be suspended not by support cables but directly by pylons arranged under the tiltable panels 20.

1. A solar installation comprising:
a supporting structure parallel to a reference direction, and
a row of panels arranged along the reference direction, each of the panels being suspended by the supporting structure, the row of panels comprising at least a first sub-assembly of tiltable panels which are each tiltable at least between a covering position and an open position by pivoting about a pivoting axis perpendicular to the reference direction and which each comprise at least one photovoltaic and/or solar thermal active element, the solar installation being wherein the row of panels comprises at least one sub-assembly of non-obscuring panels, each comprising at least one completely transparent portion at least in a range of wavelengths comprised between 350 nm and 1200 nm and which, in the covering position, allows incident light to pass through said non-obscuring panels, the non-obscuring panels being positioned so that, in the covering position, the active elements of any two successive tiltable panels of the first sub-assembly of tiltable panels are arranged along the reference direction on either side of at least one completely transparent portion of one of the non-obscuring panels.

2. The solar installation of claim 1, wherein the sub-assembly of non-obscuring panels and the first sub-assembly of tiltable panels are separate.

3. The solar installation of claim 2, wherein the non-obscuring panels are completely transparent.

4. The solar installation of claim 1, wherein the first sub-assembly of tiltable panels is included in the sub-assembly of non-obscuring panels.

5. The solar installation of claim 1, wherein the sub-assembly of non-obscuring panels comprises a second sub-assembly of tiltable panels, each of which is tiltable at least between a covering position and an open position by pivoting about a pivoting axis perpendicular to the reference direction, the first and second sub-assemblies of tiltable panels being separate.

6. The solar installation of claim 5, wherein the tiltable panels of the first sub-assembly of tiltable panels are connected by a first pivoting control cable extending parallel to the reference direction, and the tiltable panels of the second sub-assembly of tiltable panels are connected by a second pivoting control cable extending parallel to the reference direction.

7. The solar installation of claim 5, wherein two successive tiltable panels of the first sub-assembly of tiltable panels are separated by a tiltable panel of the second sub-assembly of tiltable panels, and any two successive tiltable panels of the second sub-assembly of tiltable panels are separated by a tiltable panel of the first sub-assembly of tiltable panels.

8. The solar installation of claim 5, wherein the tiltable panels of the second sub-assembly of tiltable panels each comprise at least one photovoltaic and/or solar thermal active element.

9. The solar installation of claim 1, wherein in the covering position, the row of panels forms a continuous cover.

10. The solar installation of claim 9, wherein in the covering position, the panels of the row of panels partially overlap and form a shingle arrangement along a reference position.

11. The solar installation of claim 9, wherein in the covering position, the tiltable panels come into contact with each other without overlapping along the reference direction.

12. The solar installation of claim 1, wherein the completely transparent portion of the non-obscuring panels is opaque or at least partially opaque in a range of wavelengths greater than 5 µm.
